(19) United States
(12) Patent Application Publication
(10) Pub. No.: US 2026/0220966 A1
(43) Pub. Date: Jul. 30, 2026

(54) AUTHENTICATION DEVICE

(71) Applicant: TOYOTA JIDOSHA KABUSHIKI KAISHA, Toyota-shi (JP)

(72) Inventors: Ryo SHIRAI, Toyota-shi (JP); Tsuyoshi Hoshino, Kariya-shi (JP)

(73) Assignee: TOYOTA JIDOSHA KABUSHIKI KAISHA, Toyota-shi (JP)

(21) Appl. No.: 19/439,872

(22) Filed: Jan. 5, 2026

(30) Foreign Application Priority Data
Jan. 29, 2025 (JP) 2025-013033

(51) Int. Cl. G06V 40/16; G06V 10/75; G06V 20/59; G06V 40/50; G06V 20/52

(52) U.S. Cl. CPC G06V 40/172; G06V 10/751; G06V 20/59; G06V 40/161; G06V 40/168; G06V 40/50; G06V 20/52

(57) ABSTRACT

An authentication device includes a detection unit configured to detect acquired facial feature information based on an image showing a face of a driver, a first determination unit configured to determine whether the acquired facial feature information detected based on a first image matches registered facial feature information, a second determination unit configured to determine whether the driver has put a face-worn article on the face or the face-worn article has been removed from the face based on the first image and a second image when the acquired facial feature information matches the registered facial feature information, a third determination unit configured to determine whether the acquired facial feature information detected based on the second image matches the registered facial feature information when the driver has put the face-worn article on the face or the face-worn article has been removed from the face, and a registration unit.

### CROSS-REFERENCE TO RELATED APPLICATION

This application claims priority to Japanese Patent Application No. 2025-013033 filed on January 29, 2025. The disclosure of the above-identified application, including the specification, drawings, and claims, is incorporated by reference herein in its entirety.

### BACKGROUND

### Technical Field

The present disclosure relates to an authentication device.

### Description of Related Art

An authentication device that authenticates a driver who is driving a vehicle has been proposed.

For example, in the vehicle, driving data for each driver is collected, and the collected driving data is recorded in association with the authenticated driver.

Biometric information of the driver is used for the authentication of the driver, and for example, the authentication is performed based on facial feature information representing a feature of a face of the driver.

The authentication device acquires facial feature information based on an image showing a face of a driver who is driving a vehicle, and authenticates the driver when the acquired facial feature information matches registered facial feature information. In general, the registered facial feature information is acquired based on an image showing a face on which a face-worn article such as glasses or a mask is not worn.

The driver may drive the vehicle with a face-worn article such as glasses or a mask on. When the registered facial feature information is acquired based on a face of the driver when the face-worn article is not worn, the driver who has put the face-worn article on the face may not be authenticated.

Therefore, it has been proposed to register facial feature information when the face-worn article is not worn on the face and facial feature information when the face- worn article such as glasses or a mask is worn on the face (for example, see Japanese Unexamined Patent Application Publication No. 2014-71680 (JP 2014-71680 A)).

### SUMMARY

However, in addition to the facial feature information when the face-worn article is not worn on the face, it is troublesome work for the driver to register the facial feature information when the face-worn article such as glasses or a mask is worn on the face in advance.

The present disclosure provides an authentication device that can authenticate a driver when a face-worn article such as glasses or a mask is worn on a face without registering facial feature information of the driver when the face-worn article is worn on the face in advance.

(1) According to one embodiment, an authentication device is provided. The authentication device includes: a memory configured to store one or more pieces of registered facial feature information of a face of a driver; a detection unit configured to detect acquired facial feature information of a face of a driver who is driving a vehicle based on an image showing the face of the driver; a first determination unit configured to determine whether the acquired facial feature information detected by the detection unit based on a first image matches any of the one or more pieces of registered facial feature information stored in the memory; a second determination unit configured to determine whether the driver has put a face-worn article on the face or the face-worn article has been removed from the face of the driver based on the first image and a second image showing the face of the driver who is driving the vehicle and acquired after the first image when the first determination unit determines that the acquired facial feature information matches any of the one or more pieces of registered facial feature information; a third determination unit configured to determine whether the acquired facial feature information detected by the detection unit based on the second image matches any of the one or more pieces of registered facial feature information stored in the memory when the second determination unit determines that the driver has put the face-worn article on the face or the face-worn article has been removed from the face of the driver; and a registration unit configured to record, in the memory, the acquired facial feature information detected by the detection unit based on the second image as new registered facial feature information of the face of the driver when the third determination unit determines that the acquired facial feature information detected by the detection unit based on the second image does not match any of the one or more pieces of registered facial feature information.

(2) In the authentication device according to (1), it is preferable that the second determination unit is configured to determine that the driver has put the face-worn article on the face when the face-worn article not shown in the first image is shown in the second image, and determine that the face-worn article has been removed from the face of the driver when the face-worn article shown in the first image is not shown in the second image.

(3) In the authentication device according to (1) or (2), it is preferable that the authentication device further includes a fourth determination unit configured to determine whether a driver whose face is shown in the second image and a driver whose face is shown in the first image are the same driver when the second determination unit determines that the driver has put the face-worn article on the face or the face-worn article has been removed from the face of the driver, in which the registration unit is configured to record, in the memory, the acquired facial feature information detected by the detection unit based on the second image as new registered facial feature information of the face of the driver when both of following conditions are satisfied: the third determination unit determines that the acquired facial feature information does not match any of the one or more pieces of registered facial feature information, and the fourth determination unit determines that the driver whose face is shown in the second image and the driver whose face is shown in the first image are the same driver.

(4) In the authentication device according to any one of (1) to (3), it is preferable that the fourth determination unit determines that the driver whose face is shown in the second image and the driver whose face is shown in the first image are the same driver when the second determination unit determines that the driver has put the face-worn article on the face or the face-worn article has been removed from the face of the driver before a predetermined reference time elapses from a point in time at which the first determination unit determines that the acquired facial feature information matches any of the one or more pieces of registered facial feature information.

(5) In the authentication device according to any one of (1) to (4), it is preferable that the fourth determination unit determines that the driver whose face is shown in the second image and the driver whose face is shown in the first image are the same driver when no opening or closing of a door of the vehicle occurs between a first point in time at which the first determination unit determines that the acquired facial feature information matches any of the one or more pieces of registered facial feature information and a second point in time at which the second determination unit determines that the driver has put the face-worn article on the face or the face-worn article has been removed from the face of the driver.

The authentication device of the present disclosure can authenticate the driver when a face-worn article such as glasses or a mask is worn on the face without registering the facial feature information of the driver when the face-worn article has been worn on the face in advance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an operation of the authentication device according to the present embodiment;

FIG. 2 is a hardware configuration diagram of a vehicle on which the authentication device according to the present embodiment is mounted;

FIG. 3 is an example of an operation flowchart related to a determination process of the authentication device according to the present embodiment;

FIG. 4A is a diagram illustrating an example of a registration table;

FIG. 4B is a diagram illustrating an example of a registration table in which registration authentication information is added;

FIG. 5 is an example of an operation flowchart related to an authentication process of the authentication device according to the present embodiment; and

FIG. 6 is an example of an operation flowchart related to a modification of the authentication process of the authentication device according to the present embodiment.

### DETAILED DESCRIPTION OF EMBODIMENTS

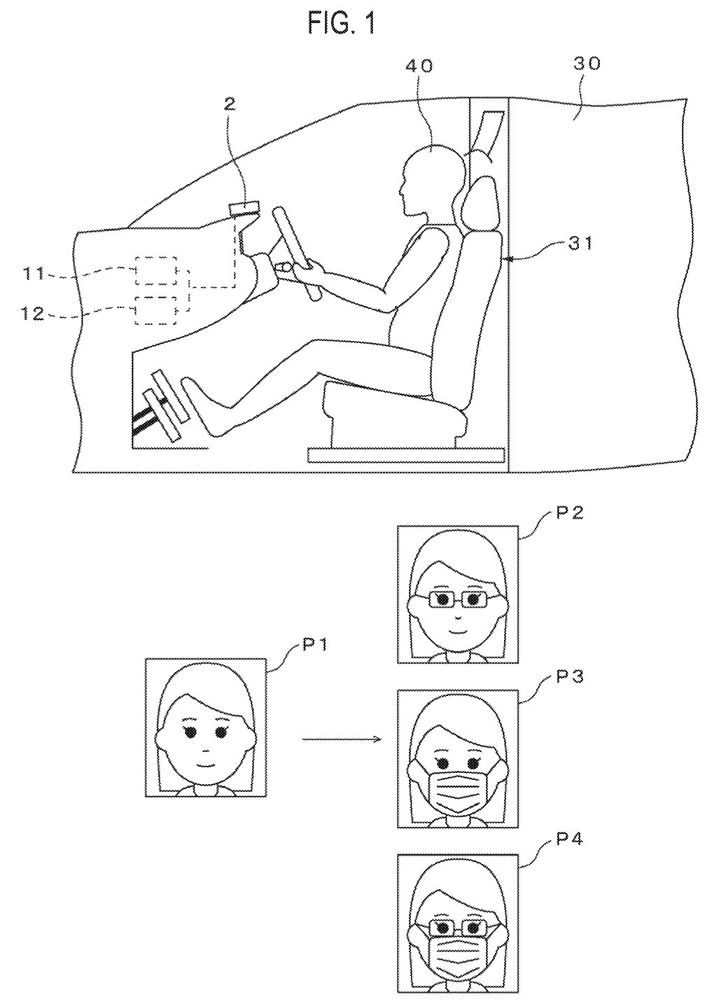

FIG. 1 is a diagram illustrating an outline of an operation of the authentication device according to the present embodiment. As illustrated in FIG. 1, a vehicle 10 includes a collection device 11 and an authentication device 12. A driver 40 sits in a driver's seat 31 in a vehicle cabin 30 to operate a steering wheel, an accelerator pedal, a brake pedal, and the like. The collection device 11 collects driving data of the vehicle 10 by the driver 40.

The authentication device 12 acquires facial feature information of the driver 40 based on a face image showing the face of the driver 40 acquired by using the surveillance camera 2, and determines whether the acquired facial feature information matches the registered facial feature information. The acquired facial feature information is an example of acquired facial feature information. The registered facial feature information is an example of registered facial feature information.

When the acquired facial feature information matches the registered facial feature information, the authentication device 12 notifies the collection device 11 that the driver 40 is authenticated. The collection device 11 records the collected driving data in association with the authenticated driver 40.

First, the driver 40 boards the vehicle 10 without putting on a face-worn article such as glasses or a mask. The authentication device 12 acquires the facial feature information of the driver 40 based on a face image P1 showing the face of the driver 40 acquired by using the surveillance camera 2, and determines that the acquired facial feature information matches the registered facial feature information. The authentication device 12 notifies the collection device 11 that the driver 40 is authenticated.

Then, the driver 40 puts on glasses while driving the vehicle 10. A face image P2 showing the face of the driver 40 who has put glasses on is acquired by using the surveillance camera 2.

The authentication device 12 determines that the driver 40 has put glasses on the face based on the face image P1 when the driver 40 is authenticated and the face image P2 acquired by using the surveillance camera 2 after the face image P1. Therefore, the authentication device 12 determines whether the facial feature information detected based on the face image P2 matches the registered facial feature information.

Since the facial feature information detected based on the face image P2 does not match the registered facial feature information, the authentication device 12 records the facial feature information detected based on the face image P2 as the facial feature information of the new driver 40. As a result, in the future, the driver 40 who has put glasses on the face is authenticated by the authentication device 12.

That is, when the driver 40 who has put glasses on the face boards the vehicle 10, the authentication device 12 acquires the facial feature information of the driver 40 based on the face image P2 showing the face of the driver 40 acquired by using the surveillance camera 2. The authentication device 12 determines that the acquired facial feature information matches the registered facial feature information.

As described above, the authentication device 12 according to the present embodiment can authenticate the driver 40 when a face-worn article such as glasses or a mask is worn on the face without registering the facial feature information of the driver 40 when the face-worn article is worn on the face in advance.

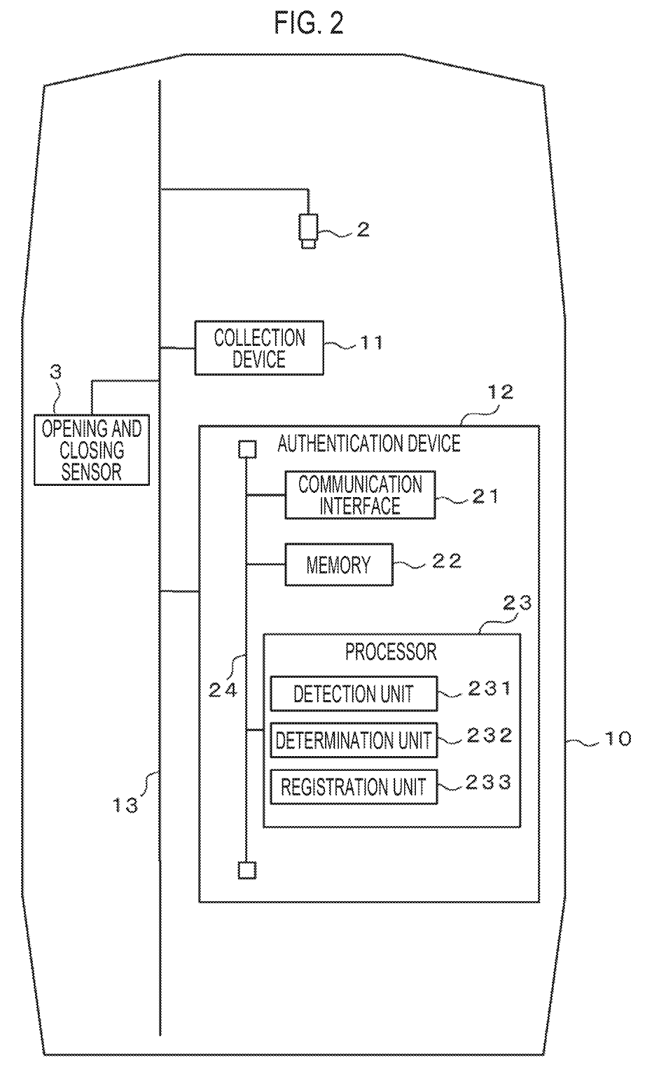

FIG. 2 is a hardware configuration diagram of the vehicle 10 on which the authentication device 12 according to the present embodiment is mounted. The vehicle 10 includes the surveillance camera 2, an opening and closing sensor 3, the collection device 11, the authentication device 12, and the like.

The surveillance camera 2, the opening and closing sensor 3, the collection device 11, and the authentication device 12 are communicably connected to each other via an in-vehicle network 13 conforming to a standard such as a controller area network.

The surveillance camera 2 is disposed in the vehicle cabin 30 to acquire a face image including the face of the driver 40 who drives the vehicle 10. The surveillance camera 2 is disposed on, for example, a dashboard. The face image acquired by the surveillance camera 2 shows the face of the driver 40 who sits in the driver's seat 31.

The surveillance camera 2 includes a two-dimensional detector configured by an array of photoelectric conversion elements having sensitivity to infrared rays, such as a CCD or a C-MOS, and an imaging optical system that forms an image of a region to be acquired on the two-dimensional detector. The surveillance camera 2 outputs the face image and an image acquisition time point at which the face image is acquired to the authentication device 12 via the in-vehicle network 13.

The opening and closing sensor 3 generates an open signal indicating that the door of the driver's seat is open and a close signal indicating that the door is closed, and outputs the open signal and the close signal to the authentication device 12 via the in-vehicle network 13.

The collection device 11 collects the driving data of the vehicle 10 and records the driving data in association with the driver 40 of the vehicle 10. The driving data includes, for example, information on a speed, an acceleration, deceleration, and the like of the vehicle 10. In addition, the driving data may include information representing an operation of the steering wheel, the accelerator pedal, the brake pedal, and the like.

The authentication device 12 executes a detection process, a determination process, and a registration process. Therefore, the authentication device 12 includes a communication interface (IF) 21, a memory 22, and a processor 23. The communication interface 21, the memory 22, and the processor 23 are connected to each other via a signal line 24. The communication interface 21 includes an interface circuit for connecting the authentication device 12 to the in-vehicle network 13.

The memory 22 is an example of a storage unit, and includes, for example, a volatile semiconductor memory and a non-volatile semiconductor memory. The memory 22 stores a computer program of an application used in information processing executed by the processor 23 and various types of data.

All or a part of functions of the authentication device 12 are, for example, function modules realized by a computer program operating on the processor 23. The processor 23 includes a detection unit 231, a determination unit 232, and a registration unit 233. The determination unit 232 is an example of a first determination unit, a second determination unit, a third determination unit, and a fourth determination unit. Alternatively, the function modules included in the processor 23 may be dedicated arithmetic circuits provided in the processor 23. The processor 23 includes one or more central processing units (CPUs) and a peripheral circuit thereof. The processor 23 may further include other arithmetic circuits such as a logic operation unit, a numerical operation unit, or a graphic processing unit.

The collection device 11 and the authentication device 12 are, for example, an electronic control unit (ECU). In FIG. 2, the collection device 11 and the authentication device 12 are described as separate devices (for example, an electronic control unit (ECU)), but these devices may be configured as one device.

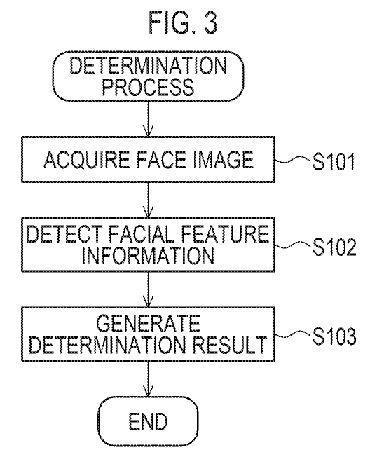

FIG. 3 is an example of an operation flowchart related to the determination process of the authentication device 12 according to the present embodiment. The authentication device 12 executes the determination process at a determination time point having a predetermined cycle according to the operation flowchart illustrated in FIG. 3.

First, the detection unit 231 acquires the face image output from the surveillance camera 2 (S101).

Next, the detection unit 231 detects a facial feature point (facial feature information) of the face of the driver 40 based on the face image (S102). The detection unit 231 includes an identifier that detects the face and the facial feature point by inputting the image. As such an identifier, the detection unit 231 can use, for example, a deep neural network (DNN) that is trained in advance to detect the face and the facial feature point shown in the image from the input image. Examples of the facial feature point include an eye, a nose, a mouth, and a contour of the face. The detection unit 231 detects a position of the eye, the nose, and the mouth, a shape of the contour of the face, and the like as the facial feature information. These pieces of facial feature information are examples, and other pieces of facial feature information may be used.

When the glasses are worn on the face, the detection unit 231 can detect the position of the eye, the nose, and the mouth, the shape of the contour of the face, and the like as the facial feature information. A position of the eye when the glasses are worn on the face may be different from a position of the eye when the glasses are not worn on the face. When the glasses are worn on the face, the eye may not be detected as the facial feature point from the image. In this case, information excluding the position of the eye is detected as the facial feature information.

When the mask is worn on the face, the detection unit 231 can detect the position of the eye, the shape of the contour of the face, and the like as the facial feature information. When the mask is worn on the face, the position of the nose may be detected as the facial feature information.

When the glasses and the mask are worn on the face, the detection unit 231 can detect the position of the eye, the shape of the contour of the face, and the like as the facial feature information. When the glasses and the mask are worn on the face, the position of the nose may be detected as the facial feature information.

Next, the determination unit 232 determines whether the facial feature information detected based on the face image matches any of one or a plurality of pieces of the facial feature information registered in a registration table 100 stored in the memory 22.

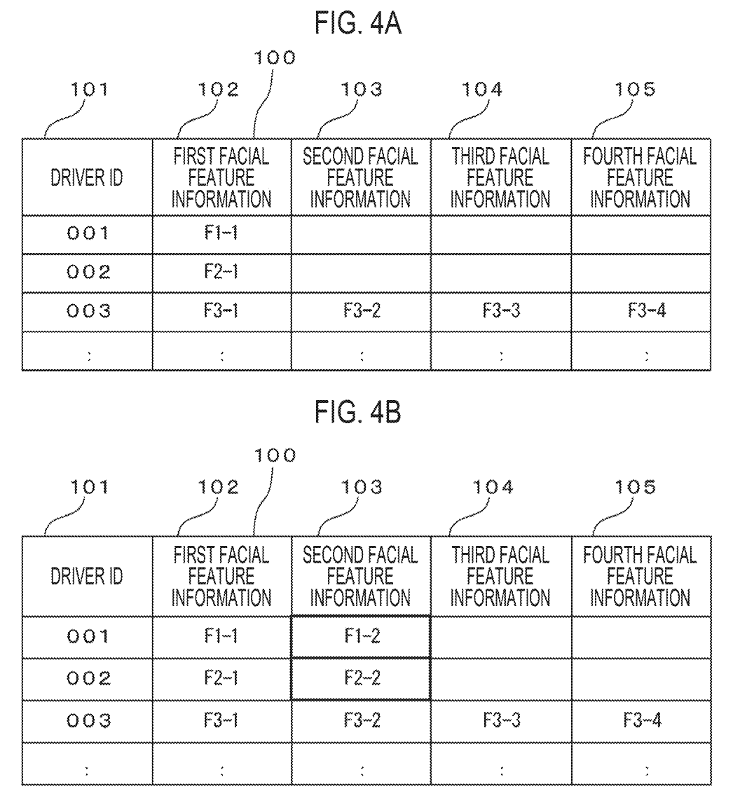

FIG. 4A is a diagram illustrating an example of the registration table 100. One or a plurality of pieces of the facial feature information are registered in the registration table 100 for each driver. The registration table 100 includes a driver ID column 101 in which driver identification information (ID) for identifying the driver is registered, and a first facial feature information column 102 in which first facial feature information is registered. The registration table 100 includes a second facial feature information column 103 in which second facial feature information is registered, a third facial feature information column 104 in which third facial feature information is registered, and a fourth facial feature information column 105 in which fourth facial feature information is registered. The driver ID, the first facial feature information, the second facial feature information, the third facial feature information, and the fourth facial feature information are registered in the registration table 100 in association with each other. In the registration table 100, the number of pieces of the facial feature information registered in association with one driver ID is an example, and is not limited thereto.

For the driver identified by the driver ID 001, first facial feature information F1-1 is registered. For example, the first facial feature information F1-1 is facial feature information of a face (for example, refer to the face image P1 of FIG. 1) on which the face-worn article is not worn.

For the driver identified by the driver ID 002, first facial feature information F2-1 is registered. For example, the first facial feature information F2-1 is facial feature information of a face (for example, refer to the face image P2 of FIG. 1) on which the glasses are worn.

For the driver identified by the driver ID 003, first facial feature information F3-1, second facial feature information F3-2, third facial feature information F3-3, and fourth facial feature information F3-4 are registered. For example, the first facial feature information F3-1 is facial feature information of a face on which the face-worn article is not worn. For example, the second facial feature information F3-2 is facial feature information of a face on which the glasses are worn. For example, the third facial feature information F3-3 is facial feature information of a face (for example, refer to the face image P3 of FIG. 1) on which the mask is worn. For example, the fourth facial feature information F3-4 is facial feature information of a face (for example, refer to the face image P4 of FIG. 1) on which the glasses and the mask are worn.

When the facial feature information detected based on the face image matches any of the pieces of the facial feature information registered in the registration table 100, the determination unit 232 performs the following process. That is, the determination unit 232 generates information indicating that the facial feature information detected based on the face image is registered as the first determination result (S103), and ends the series of processes. The first determination result includes the driver ID associated with the registered facial feature information that matches the facial feature information detected based on the face image, the face image, and the first determination time point at which the first determination result is generated.

In addition, when the facial feature information detected based on the face image does not match any of the pieces of the facial feature information registered in the registration table 100, the determination unit 232 performs the following process. That is, the determination unit 232 generates information indicating that the facial feature information detected based on the face image is not registered as the first determination result (S103), and ends the series of processes.

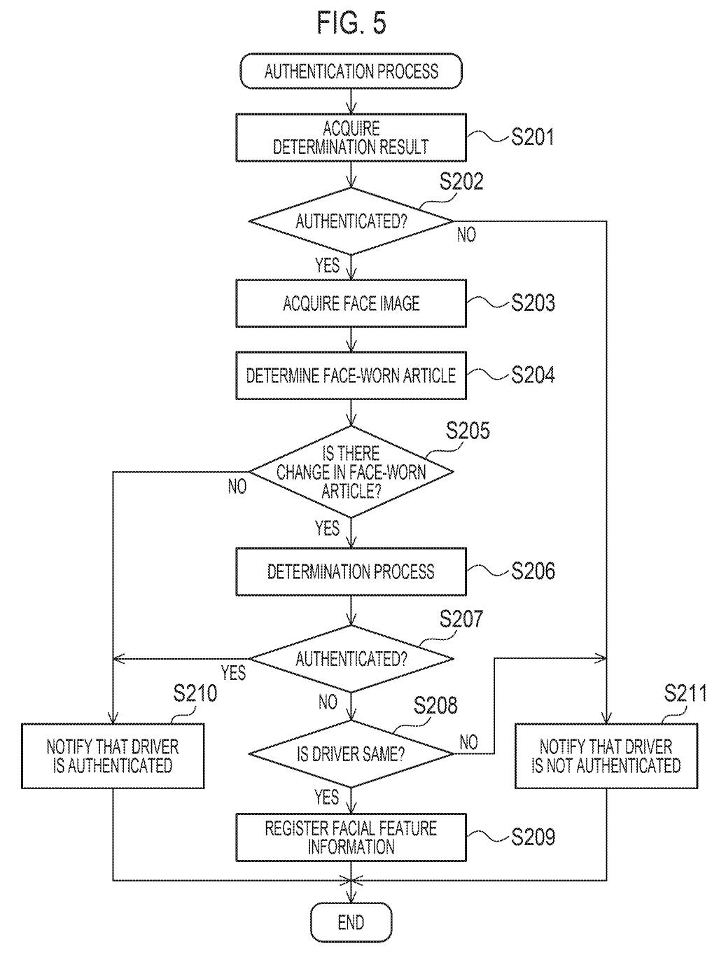

FIG. 5 is an example of an operation flowchart related to the authentication process of the authentication device according to the present embodiment. The authentication device 12 executes the authentication process at an authentication time point having a predetermined cycle according to the operation flowchart illustrated in FIG. 5. It is preferable that the cycle of the authentication process is longer than the cycle of the determination process described above.

First, the determination unit 232 acquires the first determination result of the determination process described above (S201). When the first determination result indicates that the facial feature information detected based on the face image is registered, the determination result includes the driver ID, the face image, and the first determination time point.

Next, the determination unit 232 determines whether the driver 40 shown in the face image is authenticated (S202). When the first determination result indicates that the facial feature information detected based on the face image is registered, the determination unit 232 determines that the driver 40 shown in the face image is authenticated. On the other hand, when the first determination result indicates that the facial feature information detected based on the face image is not registered, the determination unit 232 determines that the driver 40 shown in the face image is not authenticated.

When it is determined that the driver 40 shown in the face image is authenticated (Yes in S202), the determination unit 232 acquires a new face image output from the surveillance camera 2 (S203).

Next, the determination unit 232 determines whether the driver 40 has put the face-worn article on the face or the face-worn article has been removed from the face of the driver 40 based on the face image included in the first determination result and the new face image (S204). The face image included in the first determination result is also referred to as a first image hereinafter. The new face image is also referred to as a second image hereinafter. The second image is an image acquired by the surveillance camera 2 at a time point after the time point at which the first image is acquired.

The detection unit 231 detects whether the face-worn article is worn on the face shown in the image for each of the first image and the second image. The detection unit 231 includes an identifier that detects the face and the face-worn article by inputting the image. As such an identifier, the detection unit 231 can use, for example, a deep neural network (DNN) that is trained in advance to detect the face and the face-worn article shown in the image from the input image. Examples of the face-worn article include glasses and a mask. The face-worn article is not limited to these.

The detection unit 231 notifies the determination unit 232 of information indicating whether the face is shown and information indicating a type of the face-worn article when the face-worn article is detected for each of the first image and the second image. Here, when information indicating that the face is shown in the second image is not obtained, the process may return to before S201 or S202. For the first image, it is detected that the face is shown.

The determination unit 232 determines whether there is a change in the face-worn article worn on the face for the driver 40 shown in each of the first image and the second image (S205). For example, when the face-worn article is not detected for each of the first image and the second image, the determination unit 232 determines that there is no change in the face-worn article. In addition, when the same face-worn article is detected for each of the first image and the second image, the determination unit 232 determines that there is no change in the face-worn article.

On the other hand, when the face-worn article not shown in the first image is shown in the second image, the determination unit 232 determines that the driver 40 has put the face-worn article on the face. In addition, when the face-worn article shown in the first image is not shown in the second image, it is determined that the face-worn article has been removed from the face of the driver 40. When the driver 40 has put the face-worn article on the face or the face-worn article has been removed from the face of the driver 40, the determination unit 232 determines that there is a change in the face-worn article worn on the face.

When two or more face-worn articles are worn on the face in the first image, when there is a change in at least one face-worn article in the second image, the determination unit 232 determines that there is a change in the face-worn article worn on the face.

When there is a change in the face-worn article worn on the face (Yes in S205), the determination unit 232 performs the determination process (S206). The determination unit 232 determines whether the facial feature information detected by the detection unit 231 based on the second image matches any of one or a plurality of pieces of the facial feature information registered in the registration table 100 stored in the memory 22. As in S102 described above, the detection unit 231 detects the position of the eye, the nose, and the mouth, the shape of the contour of the face, and the like as the facial feature information based on the second image.

When the facial feature information detected based on the second image matches any of the pieces of the facial feature information registered in the registration table 100, the determination unit 232 performs the following process. That is, the determination unit 232 generates information indicating that the facial feature information detected based on the face image is registered as the second determination result. On the other hand, when the facial feature information detected based on the face image does not match any of the pieces of the facial feature information registered in the registration table 100, the determination unit 232 performs the following process. That is, the determination unit 232 generates information indicating that the facial feature information detected based on the second image is not registered as the second determination result. The second determination result includes the driver ID acquired together with the first image in S201.

Next, the determination unit 232 determines whether the driver 40 shown in the second image is authenticated (S207). When the second determination result indicates that the facial feature information detected based on the second image is registered, the determination unit 232 determines that the driver 40 shown in the second image is authenticated. On the other hand, when the second determination result indicates that the facial feature information detected based on the second image is not registered, the determination unit 232 determines that the driver 40 shown in the second image is not authenticated.

When the driver 40 shown in the second image is not authenticated (No in S207), the determination unit 232 determines whether the driver whose face is shown in the second image and the driver whose face is shown in the first image are the same driver (S208).

For example, suppose the second determination result is generated in which it is determined that the driver has put the face-worn article on the face or the face-worn article has been removed from the face of the driver before a predetermined reference time elapses from the first determination time point. In this case, the determination unit 232 may determine that the driver whose face is shown in the second image and the driver whose face is shown in the first image are the same driver. As the reference time, for example, 1 second to 10 seconds may be used. In such a time, it can be estimated that the driver who is driving the vehicle 10 is the same.

Suppose the door of the vehicle 10 is opened or the door of the vehicle 10 is not closed between the first determination time point and a point in time at which the second determination result is generated (hereinafter, also referred to as a second determination time point). The second determination result is a determination result that the driver has put the face-worn article on the face or the face-worn article has been removed from the face of the driver. In this case, the determination unit 232 may determine that the driver whose face is shown in the second image and the driver whose face is shown in the first image are the same driver.

When an open signal indicating that the door of the driver's seat is open is not input between the first determination time point and the second determination time point, the door of the vehicle 10 is not opened. In addition, when a close signal indicating that the door of the driver's seat is closed is not input between the first determination time point and the second determination time point, the door of the vehicle 10 is not closed.

When the door of the driver's seat is opened or the door of the driver's seat is closed between the first determination time point and the second determination time point, the driver may be changed. On the other hand, when the door of the driver's seat is not opened and the door of the driver's seat is not closed between the first determination time point and the second determination time point, it is considered that the driver is the same.

When the ignition is turned on between the first determination time point and the second determination time point, the determination unit 232 may determine that the driver whose face is shown in the second image and the driver whose face is shown in the first image are not the same driver. In addition, when it is detected that the driver newly sits in the driver's seat by using a seat sensor disposed in the driver's seat, the determination unit 232 may determine that the driver whose face is shown in the second image and the driver whose face is shown in the first image are not the same driver.

When the driver whose face is shown in the second image and the driver whose face is shown in the first image are the same driver (Yes in S208), the registration unit 233 performs the following process. That is, the registration unit 233 registers the facial feature information detected based on the second image in the registration table 100 in association with the driver ID included in the first determination result, and ends the series of processes. The registration table 100 including the facial feature information detected based on the second image is recorded in the memory 22.

On the other hand, when there is no change in the face-worn article worn on the face (No in S205), the determination unit 232 notifies the collection device 11 that the driver 40 is authenticated. Alternatively, when the driver 40 shown in the second image is authenticated (Yes in S207), the determination unit 232 notifies the collection device 11 that the driver 40 is authenticated. The collection device 11 records the collected driving data in association with the authenticated driver 40.

On the other hand, when the driver 40 shown in the first image is not authenticated (No in S202), the determination unit 232 notifies the collection device 11 that the driver is not authenticated. Alternatively, when the driver whose face is shown in the second image and the driver whose face is shown in the first image are not the same driver (No in S208), the determination unit 232 notifies the collection device 11 that the driver is not authenticated. Since the driver is not authenticated, the collection device 11 does not record the collected driving data.

Next, a specific example of the authentication process of the authentication device 12 will be described with reference to FIGS. 1, 4A and 4B.

(1) As shown in the face image P1 of FIG. 1, the first image shows the face of the driver on which the face-worn article such as glasses or a mask is not worn. The driver is identified by the driver ID 001, and the facial feature information of the driver on which the face-worn article is not worn is registered in the registration table 100 as the first facial feature information F1-1. The authentication device 12 authenticates the driver shown in the first image. Thereafter, the driver has put glasses on the face.

As shown in the face image P2 of FIG. 1, the second image shows the face of the driver on which the glasses are worn. The face-worn article worn on the face is changed, and the driver shown in the second image is not authenticated, but the driver whose face is shown in the second image and the driver whose face is shown in the first image are the same driver. Therefore, as shown in FIG. 4B, the authentication device 12 registers the second facial feature information F1-2 detected based on the second image in the registration table 100 in association with the driver ID 001. As a result, in the future, the driver who has put glasses on the face is authenticated by the authentication device 12. When the driver has put glasses different from the glasses at the time when the facial feature information is registered, the facial feature information is different, and the driver may not be authenticated.

(2) As shown in the face image P2 of FIG. 1, the first image shows the face of the driver on which the glasses are worn. The driver is identified by the driver ID 002, and the facial feature information of the driver on which the glasses are worn is registered in the registration table 100 as the first facial feature information F2-1. The authentication device 12 authenticates the driver shown in the first image. Thereafter, the driver has put a mask on the face.

As shown in the face image P4 of FIG. 1, the second image shows the face of the driver on which the glasses and the mask are worn. The face-worn article worn on the face is changed, and the driver shown in the second image is not authenticated, but the driver whose face is shown in the second image and the driver whose face is shown in the first image are the same driver. Therefore, as shown in FIG. 4B, the authentication device 12 registers the second facial feature information F2-2 detected based on the second image in the registration table 100 in association with the driver ID 002. As a result, in the future, the driver who has put the glasses and the mask on the face is authenticated by the authentication device 12.

(3) As shown in the face image P3 of FIG. 1, suppose the first image shows the face of the driver on which the mask is worn. The driver is identified by the driver ID 003, and the facial feature information of the driver on which the face-worn article is not worn is registered in the registration table 100 as the first facial feature information F3-1. In addition, information of the face of the driver on which the glasses are worn is registered in the registration table 100 as the second facial feature information F3-2. In addition, the facial feature information of the driver on which the mask is worn is registered in the registration table 100 as the third facial feature information F3-3. In addition, the facial feature information of the driver on which the glasses and the mask are worn is registered in the registration table 100 as the fourth facial feature information F3-4. The authentication device 12 authenticates the driver shown in the first image. Thereafter, the driver has put glasses on the face.

As shown in the face image P4 of FIG. 1, the second image shows the face of the driver on which the glasses and the mask are worn. The face-worn article worn on the face of the driver is changed, but the facial feature information of the driver shown in the second image is registered in the registration table 100 as the fourth facial feature information F3-4 in association with the driver ID 003, so that the driver is authenticated.

As described above in detail, according to the authentication device of the present embodiment, the driver when a face-worn article such as glasses or a mask is worn on the face can be authenticated without registering the facial feature information of the driver when the face-worn article is worn on the face in advance.

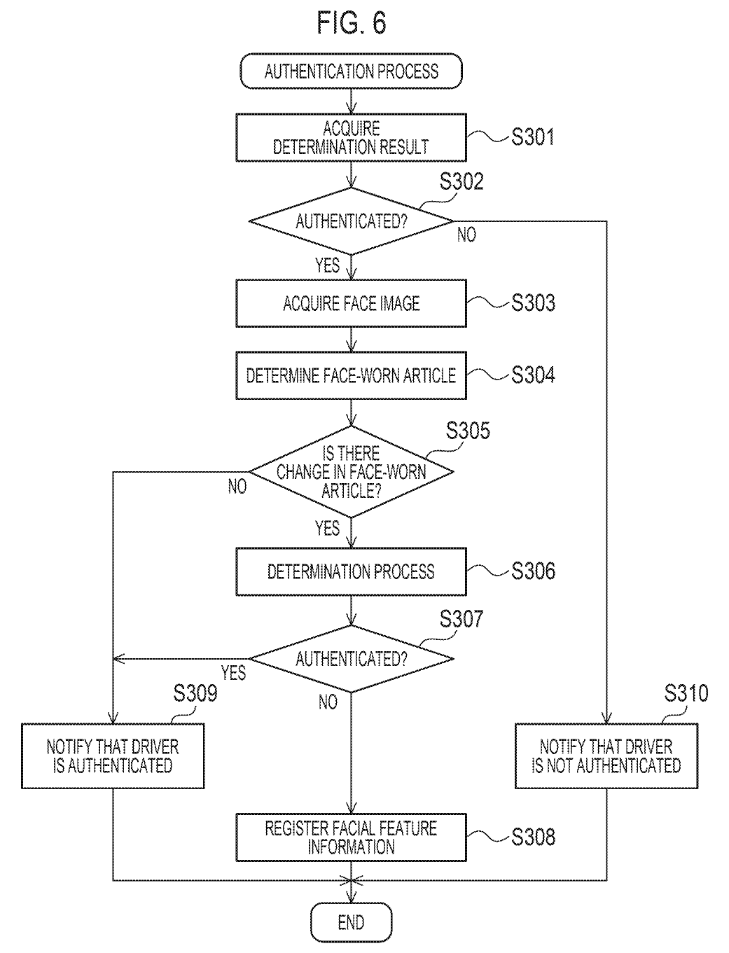

FIG. 6 is an example of an operation flowchart related to a modification of the authentication process of the authentication device 12 according to the present embodiment. In the present modification, the process of S208 in FIG. 5 is omitted.

A cycle of the authentication process illustrated in FIG. 6 is set to be sufficiently shorter than a time required for the driver to be changed, and the cycle of the determination process illustrated in FIG. 3 is set to be shorter than the cycle of the authentication process. In this case, it is considered that the driver whose face is shown in the second image and the driver whose face is shown in the first image are the same driver, so that S208 in FIG. 5 may be omitted. For example, the cycle of the authentication process illustrated in FIG. 6 may be set to 0.1 seconds to 1.0 seconds.

In the present disclosure, the authentication device of the embodiment described above can be appropriately changed as long as the gist of the present disclosure is not departed from. In addition, the technical scope of the present disclosure is not limited to the embodiments, and includes the disclosure and its equivalents described in the claims.

What is claimed is:

1. An authentication device comprising:
a memory configured to store one or more pieces of registered facial feature information of a face of a driver;
a detection unit configured to detect acquired facial feature information of a face of a driver who is driving a vehicle based on an image showing the face of the driver;
a first determination unit configured to determine whether the acquired facial feature information detected by the detection unit based on a first image matches any of the one or more pieces of registered facial feature information stored in the memory;
a second determination unit configured to determine whether the driver has put a face-worn article on the face or the face-worn article has been removed from the face of the driver based on the first image and a second image showing the face of the driver who is driving the vehicle and acquired after the first image when the first determination unit determines that the acquired facial feature information matches any of the one or more pieces of registered facial feature information;
a third determination unit configured to determine whether the acquired facial feature information detected by the detection unit based on the second image matches any of the one or more pieces of registered facial feature information stored in the memory when the second determination unit determines that the driver has put the face-worn article on the face or the face-worn article has been removed from the face of the driver; and
a registration unit configured to record, in the memory, the acquired facial feature information detected by the detection unit based on the second image as new registered facial feature information of the face of the driver when the third determination unit determines that the acquired facial feature information detected by the detection unit based on the second image does not match any of the one or more pieces of registered facial feature information.

2. The authentication device according to claim 1, wherein the second determination unit is configured to determine that the driver has put the face-worn article on the face when the face-worn article not shown in the first image is shown in the second image, and determine that the face-worn article has been removed from the face of the driver when the face-worn article shown in the first image is not shown in the second image.

3. The authentication device according to claim 1, further comprising a fourth determination unit configured to determine whether a driver whose face is shown in the second image and a driver whose face is shown in the first image are the same driver when the second determination unit determines that the driver has put the face-worn article on the face or the face-worn article has been removed from the face of the driver,
wherein the registration unit is configured to record, in the memory, the acquired facial feature information detected by the detection unit based on the second image as new registered facial feature information of the face of the driver when both of following conditions are satisfied:
the third determination unit determines that the acquired facial feature information does not match any of the one or more pieces of registered facial feature information, and
the fourth determination unit determines that the driver whose face is shown in the second image and the driver whose face is shown in the first image are the same driver.

4. The authentication device according to claim 3, wherein the fourth determination unit determines that the driver whose face is shown in the second image and the driver whose face is shown in the first image are the same driver when the second determination unit determines that the driver has put the face-worn article on the face or the face-worn article has been removed from the face of the driver before a predetermined reference time elapses from a point in time at which the first determination unit determines that the acquired facial feature information matches any of the one or more pieces of registered facial feature information.

5. The authentication device according to claim 3, wherein the fourth determination unit determines that the driver whose face is shown in the second image and the driver whose face is shown in the first image are the same driver when no opening or closing of a door of the vehicle occurs between a first point in time at which the first determination unit determines that the acquired facial feature information matches any of the one or more pieces of registered facial feature information and a second point in time at which the second determination unit determines that the driver has put the face-worn article on the face or the face-worn article has been removed from the face of the driver.
